(19) United States
(12) Patent Application Publication
(10) Pub. No.: US 2023/0116799 A1
(43) Pub. Date: Apr. 13, 2023

(54) CAPACITANCE BASED PAPER DETECTION

(71) Applicant: HEWLETT-PACKARD DEVELOPMENT COMPANY, L.P., Spring, TX (US)

(72) Inventor: Su Whan KIM, Seongnam-si (KR)

(73) Assignee: HEWLETT-PACKARD DEVELOPMENT COMPANY, L.P., Spring, TX (US)

(21) Appl. No.: 17/910,161

(22) PCT Filed: Jan. 26, 2021
(86) PCT No.: PCT/US2021/014994

§ 371 Date: Sep. 8, 2022

(30) Foreign Application Priority Data
Mar. 31, 2020 (KR) 10-2020-0038998

(51) Int. Cl. B41J 11/00; B41J 11/42; G03G 15/00; B65H 7/12; B65H 7/02

(52) U.S. Cl. CPC B41J 11/006; B41J 11/42; B65H 7/02; B65H 7/125; G03G 15/70; B65H 2511/416; B65H 2511/524; B65H 2515/805

(57) ABSTRACT

An image forming apparatus includes a print engine to form an image on recording medium, a sensor including first and second electrodes disposed to oppose each other based on a recording medium transport path, along which the recording medium is transported, and to detect a capacitance between the first and second electrodes, and a processor to determine a state of the recording medium fed along the recording medium transport path by using the capacitance detected by the sensor and to control the print engine based on the state of the recording medium.

### BACKGROUND

An image forming apparatus includes an apparatus performing generation, print, reception, transmission or the like, of image data, and may include, for example, a printer, a scanner, a copy machine, a facsimile, a multi-function peripheral in which functions of the printer, the scanner, the copy machine and the facsimile are integrally implemented.

### BRIEF DESCRIPTION OF THE DRAWINGS

FIG. 1 is a block diagram illustrating a schematic configuration of an image forming apparatus according to an example;

FIG. 2 is a block diagram illustrating an example configuration of an image forming apparatus;

FIG. 3 is a diagram illustrating an example configuration of the print engine of FIG. 1;

FIG. 4 is a diagram illustrating an example configuration of the sensor of FIG. 1;

FIGS. 5 and 6 are graphs each illustrating an example of a measurement value of capacitance for each quantity of paper;

FIGS. 7A and 7B are diagrams for describing two examples of overlapping transport;

FIG. 8 is a graph illustrating an example of a measurement value of capacitance based on a change in humidity content of paper;

FIGS. 9 and 10 are graphs each illustrating an example of a measurement value of capacitance for each thickness of paper;

FIG. 11 is a diagram illustrating an example configuration of the sensor of FIG. 1; and

FIG. 12 is a flow chart for describing an image forming method according to an example.

### DETAILED DESCRIPTION

Hereinafter, various examples are described in detail with reference to the drawings. Examples described below may be modified into several different forms.

Meanwhile, in a case that any component is referred to as being “connected to” another component in the specification, it means that any component and another component are “directly connected to” each other or are “connected to” each other with the other component interposed therebetween. In addition, in a case that any component is referred to as “including” another component, it means the inclusion of other components rather than the exclusion of other components, unless explicitly described to the contrary.

In the specification, an “image forming job” may refer to various jobs (e.g., printing, scanning, or faxing) related to an image, such as forming of the image, generating/storing/transmitting of an image file or the like, and a “job” may refer to the image forming job, as well as include a series of processes for performing the image forming job.

In addition, an “image forming apparatus” may refer to a device printing print data generated by a terminal device such as a computer on a recording paper or recording medium. The image forming apparatus may include, for example, a copier, a printer, a facsimile or a multi-function peripheral (MFP) implementing multiple functions of the copier, the printer, and the facsimile in a single apparatus.

Such an image forming apparatus may form an image on print paper picked up to a paper transport path. Here, in a case that a plurality of sheets of print paper are overlapping-transported or print paper having humidity content higher than a reference value is input, an image quality may be deteriorated or a jam may occur.

Therefore, in order to prevent the image deterioration or the jam occurrence, a determination may be made as to whether the overlapping transport occurs or the paper having high humidity content is input. Hereinafter, the description discloses examples of an image forming apparatus capable of determining whether the overlapping transport occurs and determining humidity content of the print paper.

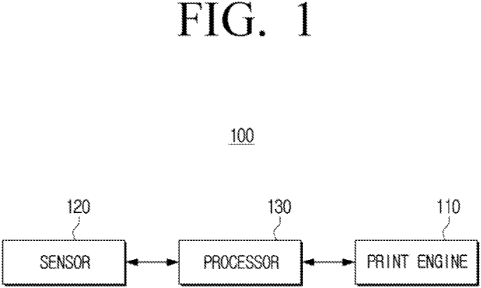

FIG. 1 is a block diagram illustrating a schematic configuration of an image forming apparatus according to an example.

Referring to FIG. 1, an image forming apparatus 100 may include a print engine 110, a sensor 120, and a processor 130.

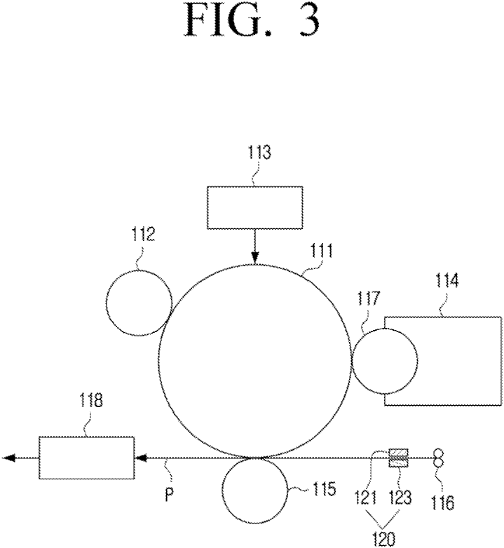

The print engine 110 may form an image on print paper. The print engine 110 may form the image using an inkjet method or using an electrophotographic method. Example configurations and operations of the print engine 110 in a case of forming the image by using the electrophotographic method are described below with reference to FIG. 3.

Here, the print paper may be referred to as a recording medium, paper or the like, and may include paper as well as a label paper, a coated paper, an overhead projector (OHP) film or the like.

The print engine 110 may perform a print job under a printing condition (e.g., a printing condition which specifies a printing speed, charging voltage, transfer voltage, fixing temperature, or the like, including combinations thereof) corresponding to a state of the print paper, which is determined by the processor 130 to be described below. This operation is described below with reference to FIG. 3.

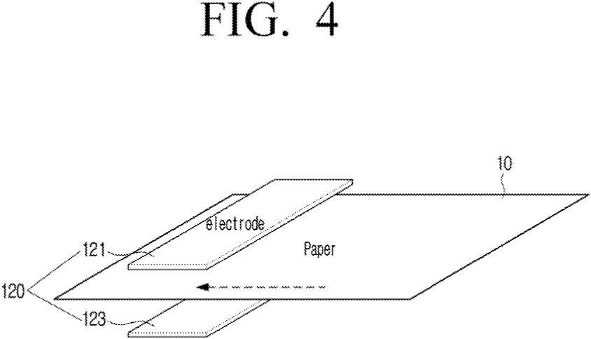

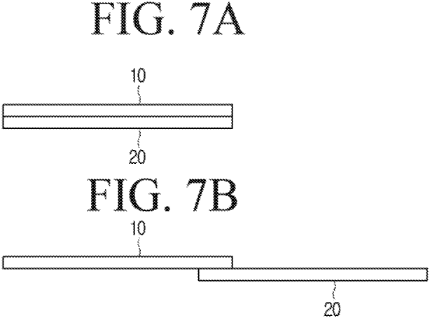

The sensor 120 may include two electrodes disposed to oppose each other based on a paper transport path, through which the print paper is transported, and may detect a capacitance between the two electrodes. Example configurations and operations of the sensor 120 are described below with reference to FIGS. 4 and 7.

The processor 130 may control an overall operation of the image forming apparatus 100. For example, the processor 130 may control the overall operation of the image forming apparatus 100 by executing at least one instruction stored in a memory 150 to be described below. The processor 130 may be implemented as a central processing unit (CPU), an application specific integrated circuit (ASIC) or the like.

The processor 130 may identify whether it is necessary to determine a state of the print paper. For example, in a case that a paper tray is opened or closed, or a new print job is received, there is a possibility that print paper different from usual is loaded on the paper tray, and the processor 130 may identify that it is necessary to determine the state of the print paper. Meanwhile, the processor 130 may be implemented to determine a state of picked-up print paper whenever the print paper is picked up.

The processor 130 may receive information on a capacitance detected by the sensor 120. For example, in a case that the sensor 120 outputs a voltage value corresponding to the capacitance, the processor 130 may determine the magnitude of the voltage value output from the sensor 120 using an internal analog-to-digital converter (ADC) terminal. The magnitude of the voltage determined here may be a voltage value corresponding to the capacitance between the two electrodes.

Meanwhile, in a case that a range of the voltage output from the sensor 120 and a range detected by the ADC terminal are different from each other, a converter (e.g., an amplifier) or the like may be additionally disposed between the sensor 120 and the processor 130 to transform the magnitude of the voltage.

The processor 130 may determine a state of fed print paper by using the capacitance detected by the sensor 120. In detail, the processor 130 may determine whether the fed print paper is in an overlapping-transport state by comparing a pre-stored capacitance (i.e., a pre-stored capacitance value or a pre-stored voltage value corresponding to the pre-stored capacitance) with the detected capacitance (i.e., the detected capacitance value or the voltage value corresponding to the detected capacitance). As another example, the processor 130 may determine whether the fed paper is in a humid state by using the capacitance detected by the sensor.

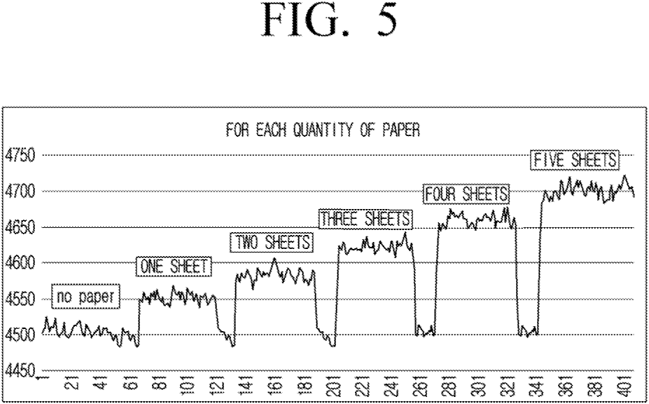

The processor 130 may determine a thickness of the fed paper using the capacitance detected by the sensor. An example operation for the paper determination by the processor 130 is described below with reference to FIGS. 5 to 10.

The processor 130 may control the print engine 110 to perform the print job based on the determined state of the print paper. For example, the processor 130 may control the print engine 110 to perform the print job under a printing condition (e.g., a printing condition that specifies a printing speed, transfer voltage, fixing temperature, charging voltage, or the like, including combinations thereof) corresponding to the determined state of the print paper.

The processor 130 may adjust the printing speed, the pick-up operation and the like based on the determined state of the print paper. For example, in a case that the print job is performed under a printing condition changed due to an occurrence of the overlapping transport, the processor 130 may adjust a pick-up time point and/or the printing speed to allow the print job to be performed under an original printing condition on a next page.

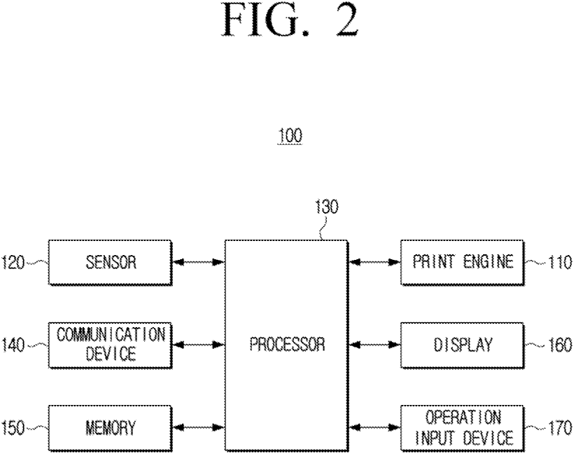

The above example illustrates and describes the schematic configuration configuring the image forming apparatus. However, the image forming apparatus may be implemented to further include various components. Example further components are described below with reference to FIG. 2.

FIG. 2 is a block diagram illustrating an example configuration of an image forming apparatus.

Referring to FIG. 2, the image forming apparatus 100 according to an example of the disclosure may include the print engine 110, the sensor 120, the processor 130, a communication device 140, a memory 150, a display 160, and an operation input device 170.

The description omits redundant explanations of the print engine 110, the sensor 120 and the processor 130, which perform the same functions as those of FIG. 1.

The communication device 140 may be formed to connect the image forming apparatus 100 to an external device, and this connection may be possible through a local area network (LAN) and the internet as well as through a universal serial bus (USB) port and a wireless module. Here, the wireless module may be WiFi, WiFi Direct, near field communication (NFC), bluetooth or the like.

In addition, the communication device 140 may receive print data from the external apparatus. Here, the print data may refer to data converted from the image forming apparatus to a printable format, and may be, for example, data of a printer language such as postscript (PS), printer control language (PCL) or the like.

The memory 150 may store at least one instruction on the image forming apparatus 100. For example, the memory 150 may store various programs (or software or machine readable instructions) for operating the image forming apparatus 100 according to various examples.

The memory 150 may store the print data received through the communication device 140. The memory 150 may be implemented by a storage medium (e.g., a non-transitory storage medium) in the image forming apparatus 100 and an external storage medium, for example, a removable disk including a universal serial bus (USB) memory, a storage medium connected to a host, a web server through a network or the like.

In addition, the memory 150 may store information set for each state of the print paper. Here, the set information may refer to various set values related to an operation of a print job in a normal state such as a fixing temperature, a charging voltage or the like, and may include a set value to be used in a case that overlapping transport occurs, a set value for each thickness of the paper, etc. In addition, the set information may have different set values for each internal or external temperature and humidity.

The display 160 may display various information provided by the image forming apparatus 100. For example, the display 160 may display a user interface window for a user to select various functions provided by the image forming apparatus 100. The display 160 may be a monitor such as a liquid crystal display (LCD), a cathode ray tube (CRT), organic light emitting diodes (OLED), or the like.

In addition, the display 160 may display a control menu for performing functions of the image forming apparatus 100. In addition, in a case that there is an error or warning state in which the overlapping transport or the jam occurs, the display 160 may display information thereon. In addition, in a case that the print job is performed on humid print paper, the display 160 may provide a warning regarding the humid state of the print paper.

The operation input device 170 may receive a function selection and a control instruction for the corresponding function from the user. Here, the function may include printing, copying, scanning, faxing and the like. This function control instruction may be input through a control menu displayed on the display 160.

The operation input device 170 may be implemented as a plurality of buttons, a keyboard, a mouse or the like, or may also be implemented as a touch screen which may simultaneously perform the above-described functions of the display 160.

As described above, the image forming apparatus 100 according to an example may accurately detect the state and feature of the print paper and change the printing condition. Therefore, the image forming apparatus 100 may prevent image deterioration due to the overlapping transport or the humidity of the print paper, as well as prevent the jam occurrence.

The examples of FIGS. 1 and 2 illustrate and describe that the print engine 110 and the sensor 120 are components different from each other. However, the sensor 120 may be implemented as a component included in the print engine 110.

FIG. 3 is a diagram illustrating an example configuration of the print engine of FIG. 1.

Referring to FIG. 3, the print engine 110 may include a photosensitive drum 111, a charger 112, an exposure device 113, a developing device 114, a transfer device 115, a paper transport device 116 and a fuser 118.

Hereinafter, for convenience of explanation, the description describes, for example, components of the printing engine 110, which correspond to one color. However, the printing engine 110 may be implemented to include a plurality of photosensitive drums 111, a plurality of chargers 112, a plurality of exposure devices 113 and a plurality of developing devices 114, which correspond to a plurality of colors.

An electrostatic latent image may be formed on the photosensitive drum 111. The photosensitive drum 111 may be referred to as a photosensitive drum, a photosensitive belt or the like based on its form.

The charger 112 may charge a surface of the photosensitive drum 111 with a uniform potential. The charger 112 may be implemented in a form such as a corona charger, a charging roller, a charging brush or the like.

The exposure device 113 may form the electrostatic latent image on the surface of the photosensitive drum 111 by changing a surface potential of the photosensitive drum 111 based on image information to be printed. For example, the exposure device 113 may form the electrostatic latent image by irradiating modulated light to the photosensitive drum 111 on the basis of image information to be printed.

The developing device 114 may accommodate a developer, and supply the developer to the electrostatic latent image to develop the electrostatic latent image into a visible image. The developing device 114 may include a developing roller 117 supplying the developer to the electrostatic latent image. For example, the developer may be supplied from the developing roller 117 to the electrostatic latent image formed on the photosensitive drum 111 by a developing electric field formed between the developing roller 117 and the photosensitive drum 111.

The paper transport device 116 may pick up print paper P from the paper tray and transport the print paper P to a discharge tray.

The sensor 120 may be positioned at a specified or predetermined location on the paper transport path, and may detect a capacitance between two electrodes 121 and 123. For example, the sensor 120 may be disposed between a feed sensor and the paper tray, or between a registration roller and the paper tray.

The visible image formed on the photosensitive drum 111 may be transferred to the print paper by the transfer device 115. Meanwhile, the example of FIG. 3 illustrates and describes a direct transfer method in which the image is formed directly on the print paper using the transfer device 115. However, the print engine may be implemented to adopt an indirect transfer method using an intermediate transfer belt.

The fuser 118 may apply heat and/or pressure to the visible image on the print paper P to fuse the visible image onto the print paper P. The print job may be completed by a series of processes as described above.

The print job may be performed through such a process, and the above-described developing condition, fixing condition, charging condition and the like may be conditions of a case in which usual print paper is input.

Therefore, in a case that a plurality of sheets of print paper are simultaneously input to the paper transport path, or the print paper having humidity content higher than the reference value is input, the image quality may be deteriorated or the jam may occur.

Therefore, in order to prevent the image deterioration or the jam occurrence, a determination may be made as to whether the overlapping transport occurs or the paper having high humidity content is input. To this end, the disclosure describes using a sensor capable of detecting the capacitance.

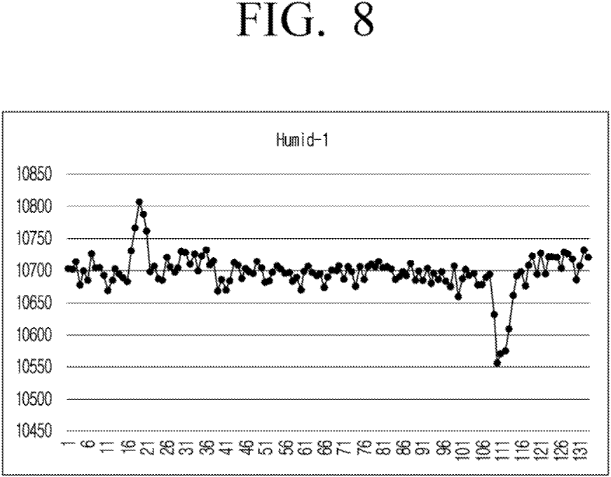

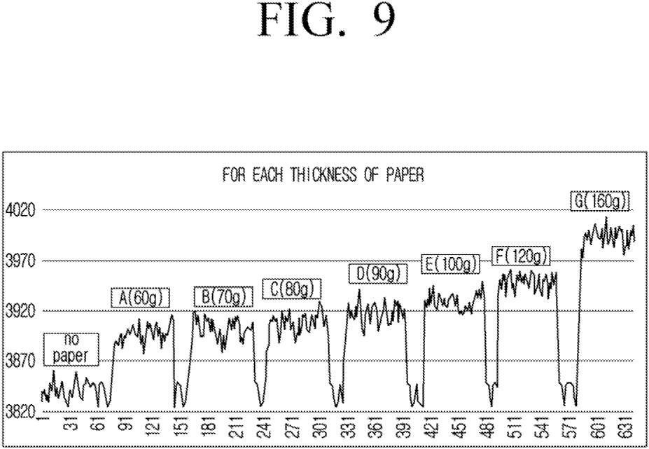

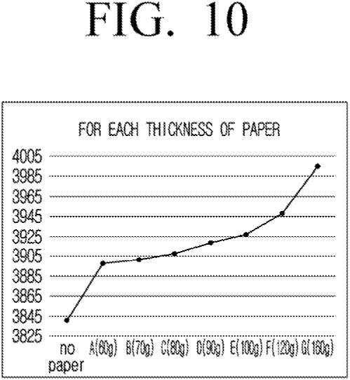

Hereinafter, an operation of determining the overlapping transport by using the capacitance is described with reference to FIGS. 5 to 7; an operation of determining humidity content of the print paper by using the capacitance is described with reference to FIG. 8, and an operation of determining a thickness of the print paper by using the capacitance is described with reference to FIGS. 9 and 10.

First, the description below describes example configurations and operations of the sensor measuring the capacitance.

FIG. 4 is a diagram illustrating an example of an example configuration of the sensor of FIG. 1.

Referring to FIG. 4, the sensor 120 may include the two electrodes 121 and 123. The below example illustrates and describes that the sensor 120 includes the two electrodes 121 and 123. However, the sensor 120 may be implemented to additionally include a component for smoothing/amplifying the voltage value corresponding to the capacitance.

The upper electrode 121 may be disposed above one point where the paper 10 passes through on the paper transport path, and have a long rectangular shape in a direction perpendicular to a direction in which the print paper is transported (i.e., the upper electrode 121 may be elongated in a direction perpendicular to the direction in which the print paper is transported).

The lower electrode 123 may be disposed below the one point where the paper 10 passes through on the paper transport path. The lower electrode 123 may be disposed to oppose the upper electrode 121 based on the one point described above. The lower electrode 123 may have a similar shape as the upper electrode 121.

The upper electrode 121 and the lower electrode 123 may each be made of a conductive material, and may be a thin metal plate. In this case, the electrode may be referred to as an electrode plate or a metal plate.

The upper electrode 121 and the lower electrode 123 may have a distance therebetween of about 5 mm. The upper electrode 121 and the lower electrode 123 may be implemented to have the distance narrower or wider than 5 mm.

The capacitance between the upper electrode 121 and the lower electrode 123 may be proportional to the surface area as in Equation 1 below, and inversely proportional to the distance.

$$\text{C} = \text{e} ∗ \text{S} / \text{d}$$

Here, C indicates the capacitance, e indicates a relative dielectric constant of a material between the electrode plates, S indicates the surface area, and d indicates the distance.

The surface area and distance of the two electrodes are fixed, and thus in a case that the print paper 10 passes through between the two electrodes, the relative dielectric constant between the electrodes is changed and accordingly, the capacitance between the two electrodes 121 and 123 is changed.

For example, the dielectric constant of the print paper is about 1.2 to 3.0, which is different from that of air. Therefore, if the print paper passes through between the two electrodes, the detected capacitance of a case in which the print paper is positioned between the two electrodes is different from the capacitance of a case in which the paper is not detected.

Based on this change, the processor may determine that the print paper is positioned between the two electrodes of the sensor 120 if capacitance currently detected is different from the capacitance (reference value) of a case in which there is no print paper. Based on this change, the processor may determine whether the paper is normally transported on the paper transport path by pickup.

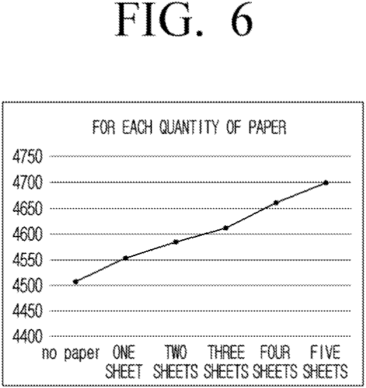

Meanwhile, in a case that a ratio of the air and the print paper between the two electrodes is changed, for example, the plurality of sheets of the print paper are positioned or thick print paper is input, capacitance different from the normal case may be detected. Based on this point, it may be determined in the disclosure whether the paper is in the overlapping-transport state by using the detected capacitance. This operation is described below with reference to FIGS. 5 and 6.

FIGS. 5 and 6 are graphs each illustrating an example of a measurement value of capacitance for each quantity of paper.

Referring to FIGS. 5 and 6, it may be confirmed that the measurement value is linearly proportional to the quantity of the print paper passing through between the two electrodes.

This feature may be used to determine whether the picked-up paper is in the overlapping-transport state. For example, if a reference capacitance of a case in which a sheet of paper passes through is known, it may be determined that the overlapping transport occurs in a case that a capacitance more than this reference capacitance is detected.

In order not to determine that the overlapping transport occurs in a case that a thick sheet of paper is input, it may be determined that the overlapping transport occurs in a case that the reference capacitance and the measured capacitance are different from each other by a certain value or more.

Capacitance measured after a predetermined event occurs may be used as the reference capacitance to be used for this determination. For example, in a case that the paper tray is opened and then closed or the power of the image forming apparatus is turned on/off, there is a possibility that the print paper loaded on the paper tray is changed. Therefore, in a case that such an event occurs, the feature of the print paper currently loaded may be determined.

For such an operation, the above-described measurement may be performed by transporting a sheet of paper to the paper transport path in advance before the print job. As another example, the measurement value for the first print paper in a first print job after opening the paper tray may be used as the reference value.

After this reference value is measured, the processor 130 may determine whether the overlapping transport occurs by comparing the measurement value for the current print paper on the paper transport path with the reference value. For example, the processor may determine that the overlapping transport occurs in a case that the measurement value is more than the reference value by the certain value or more. Meanwhile, in a case that the measurement value is less than the reference value, the processor may update the measurement value to the reference value.

Meanwhile, the overlapping transport of the print paper may occur in two forms. These forms are described with reference to FIGS. 7A and 7B.

FIGS. 7A and 7B are diagrams for describing two examples of overlapping transport.

FIG. 7A illustrates a case in which two or more sheets 10 and 20 of paper overlap each other within an allowable range between sheets of the paper not to affect timing of a paper feeding process. This overlapping transport may occur mainly in a case that the plurality of sheets 10 and 20 of the print paper are picked up together in a pickup process.

In this case, if the printing is performed under a printing condition which is the same condition as which occurs when an image is formed on a thick print paper under a printing condition for thin print paper, output quality of the paper may be deteriorated.

Therefore, it may be determined that the overlapping transport as illustrated in FIG. 7A occurs if it is determined that a capacitance value output from the sensor is changed and the paper is input, and the changed capacitance value corresponds to a value for the plurality of sheets of paper.

In this case, the processor may change the printing condition (e.g., an increase in the fixing temperature or the like), and the processor may control the print engine 110 to perform the print job under the changed printing condition.

In addition, in a case that the printing of the print paper in the overlapping-transport state is completed, the processor 130 may restore the temporarily changed printing condition to the original printing condition.

FIG. 7B illustrates a case in which the two or more sheets 10 and 20 of the paper affect the timing of the paper feeding process, and are outside the allowable range between sheets of the paper. This overlapping transport may occur mainly in case that the first sheet 10 is picked up, and the second paper is transported to the paper transport path by frictional force between the first paper 10 and the second paper 20.

If this type of overlapping transport occurs, the jam error may occur in an image forming apparatus.

Meanwhile, according to examples of the disclosure, the print job may be performed without such a jam error even in this case. For example, it may be determined that the overlapping transport as illustrated in FIG. 7B occurs if it is determined that the capacitance value output from the sensor is changed and the paper is input, and the capacitance value is changed step by step after the paper is input.

In a case that this overlapping transport is determined, the processor may change the printing condition (e.g., the increase in the fixing temperature or the like), and control the print engine to perform the print job under the changed printing condition. In addition, the processor may prevent a pickup operation of the next page from being performed until all the sheets 10 and 20 of the print paper are discharged, and allow the pickup operation of the next print paper to be performed after the print paper is discharged.

Through this operation, even in a case that the overlapping transport occurs, the printing operation may be continuously performed without the jam occurrence.

As described above, the image forming apparatus according to an example may determine the overlapping-transport state by using the capacitance between the two electrodes, and may perform the print job without deteriorating the print quality even in a case that the overlapping transport occurs.

FIG. 8 is a graph illustrating an example of capacitance based on a change in humidity content of paper. For example, FIG. 8 illustrates the capacitance detected by the sensor in a predetermined time unit. Here, a first region protruding upward may indicate capacitance of a case in which the usual print paper passes through, and a second region protruding downward may indicate capacitance of a case in which the humid print paper passes through.

Referring to FIG. 8, it may be confirmed that if the humidity content of the paper is a certain amount or more, the capacitance is lower than that of a case in which no paper is detected. The reason is that the capacitance is removed by an antistatic brush and thus, the capacitance is measured lower than that of the case in which there is no paper.

If the humidity content of the print paper is high, a curl may occur on the paper, resulting in a wrinkle or the jam. In addition, resistance of a paper surface may be lowered, resulting in leakage of the transfer voltage, which may cause a defective transfer.

Thus, the above-described feature detected by the sensor may be used to determine whether the picked-up paper is humid. For example, if a smaller capacitance is detected than that of a case in which the print paper does not pass through, it may be determined that the humid print paper is input.

In addition, if it is determined that the humid print paper is input, the processor may adjust the printing speed to prevent the curl or jam from occurring. In addition, the processor may additionally change at least one of an increase in the transfer voltage or the increase in the fixing temperature.

Meanwhile, the print paper is usually shipped from a factory to have a humidity content of about 50 to 60. However, the curl may easily occur if the humidity content of the paper is increased because humidity in a surrounding printing environment is high after the shipment.

However, even though the surrounding printing environment is not under a high-temperature/high-humidity condition, the humidity content of the paper may be high depending on the state of the paper. The print quality may thus be deteriorated if the printing job is performed by simply determining that the paper is not humid based on the measurement values of a temperature/humidity sensor in the image forming apparatus.

Therefore, even in a case that the temperature/humidity sensor does not indicate the high-temperature/high-humidity condition, the processor may determine the humidity content of the print paper based on the capacitance, and may perform the print job by changing the printing condition based on the determined humidity content of the paper.

FIGS. 9 and 10 are graphs each illustrating an example of capacitance for each thickness of paper.

Referring to FIGS. 9 and 10, it may be confirmed that the measurement value is linearly proportional to the thickness of the print paper passing through between the two electrodes.

Such a feature may be used to determine the thickness of the picked-up paper. For example, if the capacitance value (or range) measured for each sheet of the paper is known, the thickness of the print paper may be determined using the measured capacitance.

Therefore, the processor may determine the thickness (or basis weight or feature) of the print paper based on the measured capacitance. In addition, the processor may perform the print job by adjusting a control value of a developing processor based on the determined value.

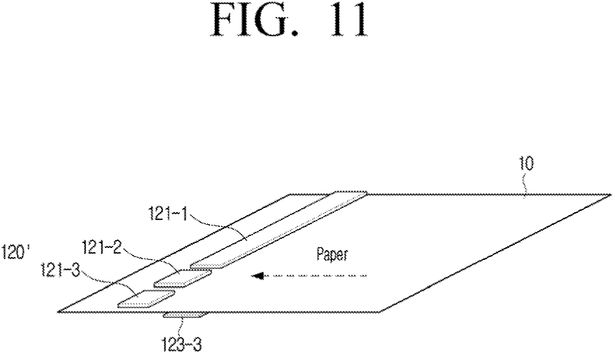

Described above is a method of detecting the overlapping transport, thickness and humidity content of the print paper by using the capacitance detected by the sensor. As described above, the capacitance is proportional to the surface area, and therefore, it is also possible to detect a size of the print paper by changing an arrangement form of the electrode. This example is described below with reference to FIG. 11.

FIG. 11 is a diagram illustrating another example of the sensor of FIG. 1.

Referring to FIG. 11, a sensor 120′ may include a first upper electrode 121-1, a second upper electrode 121-2 and a third upper electrode 121-3, which are disposed above a paper transport path, and a first lower electrode (not illustrated), a second lower electrode (not illustrated) and a third lower electrode 123-3, which are disposed to oppose the upper electrodes, respectively. Here, the first lower electrode (not illustrated) may be disposed to oppose the first upper electrode 121-1, the second lower electrode (not illustrated) may be disposed to oppose the second upper electrode 121-2, and the third lower electrode 123-3 may be disposed to oppose the third upper electrode 121-3.

The processor may detect capacitance between the first upper electrode 121-1 and the first lower electrode (not illustrated), capacitance between the second upper electrode 121-2 and the second lower electrode (not illustrated), and capacitance between the third upper electrode 121-3 and the third lower electrode 123-3, respectively.

In addition, the processor may determine a paper state and a paper size of an input print paper 10 by using the detected capacitance. For example, the processor may determine the paper state by using two electrodes each positioned at a location (for example, a center of a main scanning direction) capable of detecting all the paper, and may determine the paper size by using a change in capacitance measured at the remaining electrodes.

Meanwhile, the above example illustrates and describes that the upper and lower electrodes are divided into three electrodes, respectively. However, in another example one set of the upper or lower electrodes may be divided to have a plurality of electrode regions, and the other set may be implemented as a single electrode. In addition, the electrodes may be divided to have either two regions or four or more regions instead of three regions.

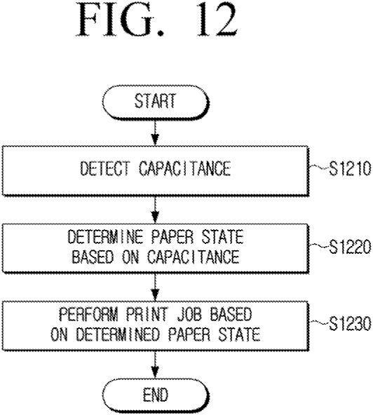

FIG. 12 is a flow chart for describing an image forming method according to an example.

Referring to FIG. 12, it is possible to detect capacitance between two electrodes disposed to oppose each other based on a paper transport path through which print paper is transported (S1210).

Then, a state of fed print paper may be determined by using the detected capacitance (S1220). For example, it may be determined that the fed print paper is in an overlapping-transport state in a case that a pre-stored capacitance is compared with the detected capacitance and as a result, the detected capacitance is more than the pre-stored capacitance. As another example, it may be determined that the fed print paper is in a humid state in a case that the detected capacitance is smaller than a capacitance detected by the sensor in a case in which the print paper is not positioned along the paper transport path at a position between the first and second electrodes.

An image may be formed on the print paper based on the determined state of the print paper (S1230). For example, the image may be formed by changing a printing condition in a case that the fed print paper is determined to be in the overlapping-transport state. In addition, the image may be formed by changing at least one of a decrease in printing speed, a change in transfer voltage, or an increase in fixing temperature in a case that the fed print paper is determined to be in a humid state.

As described above, the image forming method according to various examples may accurately detect the state and feature of the print paper and change the printing condition. Therefore, the image forming method may prevent image deterioration due to the overlapping transport or the humidity of the print paper, as well as prevent the jam occurrence.

In addition, the image forming method as described above may be implemented by at least one execution program for executing the image forming method as described above, and such an execution program may be stored and provided in a non-transitory computer readable medium.

Although the examples are illustrated and described in the disclosure as above, the disclosure is not limited to the above mentioned examples, and may be variously modified without departing from the scope of the disclosure as disclosed in the accompanying claims. These modifications also fall within the scope and spirit of the disclosure.

What is claimed is:

1. An image forming apparatus, comprising:
a print engine to form an image on a recording medium;
a sensor including a first electrode and a second electrode, the first electrode being disposed to oppose the second electrode based on a recording medium transport path, along which the recording medium is transported, and to detect a capacitance between the first and second electrodes; and
a processor to determine a state of the recording medium fed along the recording medium transport path by using the capacitance detected by the sensor and to control the print engine based on the state of the recording medium.

2. The image forming apparatus as claimed in claim 1, wherein the processor is to determine whether the recording medium fed along the recording medium transport path is in an overlapping-transport state by comparing a pre-stored capacitance with the capacitance detected by the sensor.

3. The image forming apparatus as claimed in claim 2, wherein the processor is to change a printing condition and control the print engine to form the image under the changed printing condition, when the processor determines the recording medium fed along the recording medium transport path is in the overlapping-transport state.

4. The image forming apparatus as claimed in claim 2, wherein the processor is to control the print engine to stop a print job for the recording medium fed along the recording medium transport when the processor determines the recording medium fed along the recording medium transport path is in the overlapping-transport state.

5. The image forming apparatus as claimed in claim 2, further comprising:
and a recording medium tray in which the recording medium is to be loaded;
a recording medium transport device to pick up the recording medium loaded on the recording medium tray and to transport the recording medium onto the recording medium transport path from the recording medium tray,
wherein the processor is to control the recording medium transport device to pick up a next recording medium after the recording medium is discharged when the processor determines the recording medium fed along the recording medium transport path is in the overlapping-transport state.

6. The image forming apparatus as claimed in claim 2, further comprising a recording medium tray in which the recording medium is to be loaded,
wherein the processor is to store the capacitance detected by the sensor for a recording medium which is first picked-up after the recording medium tray is opened and closed, as the pre-stored capacitance.

7. The image forming apparatus as claimed in claim 1, wherein the processor is to determine that the recording medium fed along the recording medium transport path is in a humid state when the capacitance detected by the sensor is less than a capacitance detected by the sensor when the recording medium is not positioned along the recording medium transport path at a position between the first and second electrodes.

8. The image forming apparatus as claimed in claim 7, wherein the processor is to control the print engine to perform a print job by changing at least one of a printing speed, a transfer voltage, or a fixing temperature, when the processor determines the recording medium fed along the recording medium transport path is in the humid state.

9. The image forming apparatus as claimed in claim 1, wherein the processor is to determine a thickness of the recording medium based on the capacitance detected by the sensor and is to control the print engine based on the thickness.

10. The image forming apparatus as claimed in claim 1, wherein the sensor is positioned on the recording medium transport path between a feed sensor and a recording medium tray or between a registration roller and the recording medium tray.

11. The image forming apparatus as claimed in claim 1, wherein the first electrode is disposed at a point on the recording medium transport path and has a rectangular shape with a longer side extending in a first direction which is perpendicular to a second direction by which the recording medium is transported along the recording medium transport path; and
the second electrode is disposed to oppose the first electrode based on the point on the recording medium transport path, and
the recording medium is transported along the recording medium transport path between the first electrode and the second electrode.

12. The image forming apparatus as claimed in claim 11, wherein
the sensor includes a plurality of first electrodes which are disposed to be spaced apart from each other in the first direction and is to detect the capacitance using the plurality of first electrodes, and
the processor is to determine a size of the recording medium based on the capacitance detected by the sensor.

13. A non-transitory machine-readable storage medium encoded with instructions, that when executed, cause an image forming apparatus to:
detect a capacitance between a first electrode and a second electrode, the first electrode being disposed to oppose the second electrode based on a recording medium transport path along which a recording medium is transported;
determine a state of the recording medium fed along the recording medium transport path by using the capacitance; and
form an image on the recording medium based on the state of the recording medium determined using the capacitance.

14. The non-transitory machine-readable storage medium as claimed in claim 13, wherein the non-transitory machine-readable storage medium is further encoded with instructions, that when executed, cause the image forming apparatus to:
determine the state of the recording medium by determining whether the recording medium fed along the recording medium transport path is in an overlapping-transport state based on a comparison of a pre-stored capacitance with the capacitance, and
form the image on the recording medium by changing a printing condition, when the recording medium is determined to be in the overlapping-transport state.

15. The non-transitory machine-readable storage medium as claimed in claim 13, wherein the non-transitory machine-readable storage medium is further encoded with instructions, that when executed, cause the image forming apparatus to:
determine the state of the recording medium by determining the recording medium fed along the recording medium transport path is in a humid state when the capacitance is less than a capacitance detected when the recording medium is not positioned along the recording medium transport path at a position between the first and second electrodes, and
form the image on the recording medium by changing at least one of a decrease in a printing speed, an increase in a transfer voltage, or an increase in a fixing temperature, when the recording medium is determined to be in the humid state.
